(19) United States
(12) Patent Application Publication
(10) Pub. No.: US 2015/0339521 A1
(43) Pub. Date: Nov. 26, 2015

(54) PRIVACY PROTECTION METHOD OF HUMAN BODY SECURITY INSPECTION AND HUMAN BODY SECURITY INSPECTION SYSTEM

(71) Applicants: Tsinghua University, Haidian District, Beijing (CN); Nuctech Company Limited, Haidian District, Beijing (CN)

(72) Inventors: Zhiqiang CHEN, Haidian District, Beijing (CN); Ziran ZHAO, (CN); Yuanjing LI, Haidian District, Beijing (CN); Wanlong WU, Haidian District, Beijing (CN); Xianli DING, Haidian District, Beijing (CN); Li ZHANG, Haidian District, Beijing (CN); Yingkang JIN, Haidian District, Beijing (CN); Zongjun SHEN, Haidian District, Beijing (CN); Le TANG, Haidian District, Beijing (CN)

(21) Appl. No.: 14/414,515

(22) PCT Filed: Jul. 23, 2014
(86) PCT No.: PCT/CN2014/082823

§ 371 Date: Jan. 13, 2015

(30) Foreign Application Priority Data
Jul. 23, 2013 (CN) 201310311425.X
Aug. 5, 2013 (CN) 201310336995.4

(51) Int. Cl. G06K 9/00; G07C 9/00; G06T 7/00

(52) U.S. Cl. CPC G06K 9/00362; G06T 7/0002; G07C 9/00158; G06T 2207/30196; G06T 2207/30232

(57) ABSTRACT

The present invention provides a privacy protection method and a human body security inspection system having the same function. The privacy protection method comprises the steps of: acquiring in real-time scanning row or column image data of a personal to be inspected; displaying a physical profile image and an outline image of the personal to be inspected, on basis of the processed image of the scanning row or column image data; transmitting the physical profile image to an equipment end display in a human body security inspection system and displaying it thereon, and displaying the outline image of the personal to be inspected on a remote operation end display of the human body security inspection system; performing the suspicious matter recognition based on the outline image; and correspondingly displaying a suspected frame on the physical profile image, based on the suspicious matter recognized in the outline image.

### CROSS-REFERENCE TO RELATED APPLICATION

This application claims priorities to Chinese Patent Application Nos. 201310311425.x filed on Jul. 23, 2013 and 201310336995.4 filed on Aug. 5, 2013, both entitled “privacy protection method of human body security inspection and human body security inspection system”, in the State Intellectual Property Office of China, the disclosures of which are incorporated herein by reference in their entireties.

### BACKGROUND OF THE INVENTION

1. Field of the Invention

The present disclosure generally relates to a technical field of human body security inspection, in particular to a privacy protection method of human body security inspection and the relevant system thereof.

2. Description of the Related Art

Personal privacy protection has become one of the most concerned issues in the human body security inspection. Since the image thereof discloses too much information about detailed features of the human body, this may give rise to invasion of privacy. Because this also brings about the serious dissatisfaction of a personal to be inspected, the relevant inspection devises have been removed in some countries, and replaced by new human body security inspection system having privacy protection function. Therefore, the privacy protection function will become one essential feature of the inspection system.

Presently, the privacy protection method of human body inspection mainly utilizes human body outline images and cartoon images. However, the human body outline image will display some feature information of the personal to be inspected (with reference to FIG. 4, the outline image of which usually exposes some privacy information or sites). Although the human body cartoon image does not display the feature information of the human body, there will be deviation between a suspicious matter marked position and a real position thereof, due to mismatch of the cartoon image to the real image (i.e., there are obvious differences on terms of physical profile, standing posture, standing position or the like). The deviation is relevant to the matching degree.

In view of this, there indeed is a need to provide a human body security inspection method having good privacy protection function and accurately displaying information of the suspicious matter, and the relevant system thereof.

### SUMMARY OF THE INVENTION

The present invention aims to solve at least one aspect of the above problems and drawbacks in the prior art.

In order to solve the problems of privacy protection and accurately displaying the suspicious matter in the human body security inspection, one privacy protection method for the human body security inspection and a human body security inspection system are proposed out herein, wherein the physical profile image of the personal to be inspected is used to replace the original scanning image, as the image with the suspected frame.

In accordance with one aspect of the present invention, it provides a privacy protection method for human body security inspection, comprising the steps of:
acquiring in real-time scanning row or column image data of a personal to be inspected;
displaying a physical profile image and an outline image of the personal to be inspected, on basis of the processed image of the scanning row or column image data;
transmitting the physical profile image to an equipment end display in a human body security inspection system and displaying it thereon, and displaying the outline image of the personal to be inspected on a remote operation end display of the human body security inspection system;
performing a suspicious matter recognition based on the outline image; and
correspondingly displaying a suspected frame on the physical profile image, based on the suspicious matter recognized in the outline image.

In one embodiment, the privacy protection method further comprises:
a step of optimizing the physical profile image and the outline image based on an entire original scanning image of the personal to be inspected obtained after completing the scanning, after the step of displaying in real-time the physical profile image and the outline image of the personal to be inspected.

In one embodiment, the suspected frame matched with the suspicious matter is correspondingly displayed on the physical profile image, based on a sort of the recognized suspicious matter and its position and size in the outline image.

In one embodiment, a colour of the suspected frame represents the sort of the suspicious matter.

In one embodiment, a suspected blue frame represents a metal article, a suspected green frame represents a non-metal article, and a suspected red frame represents explosives or drugs.

In one embodiment, the physical profile image is fully matched with an outline of the personal to be inspected, but excludes detailed features of the personal to be inspected.

In one embodiment, the physical profile image and the outline image of the personal to be inspected are simultaneously obtained from the original scanning image, by means of the algorithm processing module in the human body security inspection system.

In one embodiment, the physical profile image is obtained by removing the detailed features of the personal to be inspected with algorithm of the algorithm processing module.

In one embodiment, during the removing step, the algorithm is used to mend and remove concave and/or convex portions of edges of the physical profile image and/or holes in an interior of the physical profile image caused by presence of the suspicious matter

In one embodiment, the outline image is obtained by denoising and contour extracting the original image.

In accordance with another aspect of the present invention, it provides a human body security inspection system with privacy protection function, comprising:
a device configured to acquire scanning images of a personal to be inspected within a scanning region;
a device configured to obtain a physical profile image of the personal to be inspected based on the scanning images;
a device configured to obtain an outline image of the personal to be inspected based on the scanning images;
a device configured to determine a suspicious matter carried by the personal to be inspected from the outline image;
a device configured to display a suspected frame on the physical profile image based on the suspicious matter recognized in the outline image; and
a device configured to display the physical profile image and the outline image on an equipment end display and a remote operation end display of the human body security inspection system respectively in a form of split-display.

In one embodiment, the suspected frame matched with the suspicious matter is correspondingly displayed on the physical profile image, based on a sort of the recognized suspicious matter and its position and size in the outline image.

In one embodiment, a colour of the suspected frame represents the sort of the suspicious matter.

In one embodiment, a suspected blue frame represents a metal article, a suspected green frame represents a non-metal article, and a suspected red frame represents explosives or drugs.

In one embodiment, the physical profile image is fully matched with an outline of the personal to be inspected, but exclude detailed features of the personal to be inspected.

In one embodiment, the physical profile image and the outline image of the personal to be inspected are simultaneously obtained from the original scanning image, by means of an algorithm processing module in the human body security inspection system.

In one embodiment, the physical profile image is obtained by removing the detailed features of the personal to be inspected with algorithm of the algorithm processing module.

In one embodiment, during the removing step, the algorithm is used to mend and remove concave and/or convex portions of edges of the physical profile image and/or holes in an interior of the physical profile image caused by presence of the suspicious matter.

In one embodiment, the outline image is obtained by denoising and contour extracting the original scanning image.

In the embodiments of the present invention, the privacy protection method for the human body security inspection removes the detailed information of the human body and information about the supplementary articles (for example, suspicious matter) by for example, image processing and software technique and mends the incomplete image and the holes caused by the supplementary articles. Only the physical profile image (similar to the projected image formed by projecting the parallel lights onto the human body) of the human body not containing the detailed features of the human body is displayed on the display operated by the inspection operator (i.e., the equipment end display), and only a suspected frame is displayed at the position of the suspicious matter in the image.

In the privacy protection method of the present application, since only the profile image excluding the detailed features of the personal to be inspected and fully matched with the human body is displayed on the equipment end display, and a suspected frame is merely present at the position of the suspicious matter in the image, it has good privacy protection function and practical utility.

### BRIEF DESCRIPTION OF THE DRAWINGS

These and other aspects as well as advantages of the present invention will become apparent and readily understood from the description of the preferred embodiments taking in conjunction with the accompanying drawings, in which like reference numerals represent like components.

FIG. 1 shows a schematic view of a human body back-scatter scanning system in accordance with an embodiment of the present invention;

FIG. 2 shows a schematic view of a human body back-scatter scanning system in accordance with another embodiment of the present invention;

FIG. 3 shows a flowchart of a privacy protection method for inspecting human body security in accordance with an embodiment of the present invention; and

FIG. 4 shows a physical profile image and an outline image of a personal to be inspected displayed on a remote operation end display and an equipment end display, which are obtained from the privacy protection method of the human body security inspection in accordance with an embodiment of the present invention.

### DETAILED DESCRIPTION OF THE EMBODIMENTS

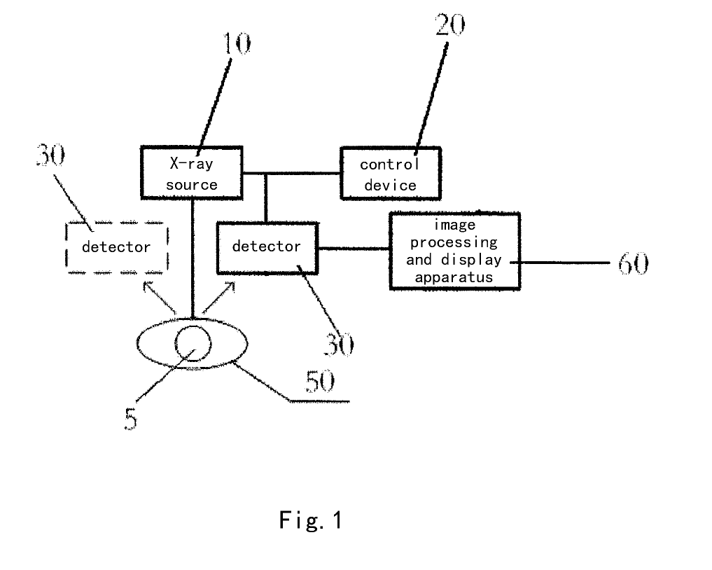

Technical solutions of the present invention will be described hereinafter in more detail by the way of embodiment with reference to FIGS. 1-4 of the attached drawings, wherein the same or like reference numerals refer to the same or like elements throughout the specification. The explanation to the embodiment of the present invention with reference to the accompanying drawings is intended to interpret the general inventive concept of the present invention, rather than being construed as a limiting to the present invention.

The specific embodiments of the present invention will be described in detail below. It should be noted that embodiments described herein are depicted only for illustration, instead of limiting to the present invention. In order to understand the present invention comprehensively, a number of specific details are provided in the following description. However, it is obvious for those skilled in the art that implementation of the present invention exactly by the specific details is not necessary. In other embodiments, the well-known structures, materials and methods are not specifically described herein, in order to avoid obscuring the present invention.

Throughout the description of the present invention, a reference to “one embodiment”, “an embodiment”, “one example” or “an example” is meant that the specific features, structures, or characteristics described in a combination with this embodiment or example are incorporated into at least one embodiment of the present invention. Therefore, phrases “in one embodiment”, “in an embodiment”, “in one example”, or “in the example” present in the description of the present invention does not means the same embodiment or the same example. In addition, it is possible to combine the specific features, structures or characteristics into one or more embodiments or examples, in any suitable combination and/or sub-combination. Furthermore, the ordinary person skilled in the art should appreciate that the expression “and/or” used herein includes any combination or all combinations of one or more relevant items listed herein.

Since in the prior art it is impossible to perform the privacy protection and accurately display specific information about the suspicious matter in the case of using the outline image or cartoon image, some embodiments of the present invention provide a privacy protection method of the human body security inspection and the relevant apparatus or system.

In the privacy protection method of the human body security inspection or the human body security inspection system in accordance with the embodiment of the present invention, acquiring in real-time scanning row or column image data of a personal to be inspected, is firstly obtained by scanning one side or more sides of the personal with a human body back-scatter scanning system for example. Then, based on the processed image of the scanning row or column image data, a physical profile image and an outline image of the personal to be inspected are displayed in real-time. The physical profile image is transmitted to the equipment end display for display, while the outline image of the personal to be inspected is displayed on a remote operation end display. After that, suspecious matter recognition is performed in the outline image, and a suspected frame is correspondingly displayed on the physical profile image on basis of the suspicious matter recognized in the outline image. In one preferred embodiment, the outline image and the physical profile image according to an embodiment of the present invention can be obtained after optimizing treatment is done on the obtained entire scanning image of the personal to be inspected.

FIG. 1 shows a schematic view of the human body back-scatter scanning system in accordance with an embodiment of the present invention. As shown in FIG. 1, the human body back-scatter scanning system includes a X-ray source 10, a detector 30, a control device 20 and an image processing and display apparatus 60. The control device 20 controls the X-ray source 10 to emit X-rays. By means of modulation by a flying spot forming device (not shown), flying spots are generated to scan a body surface of the human body 5 or the personal to be inspected within an inspection region 50, and the control device 20 controls the detector 30 to detect the X-rays scattered by the inspected human body, thereby forming a back-scatter image. In this way, if it is necessary to scan several sides of the human body, then it will be possible to obtain the back-scatter images of the sides of the human body after such scanning as described above. Then, the back-scatter image(s) of one side or more sides of the inspected human body is/are processed within the image processing and display apparatus 60, for instance by a software.

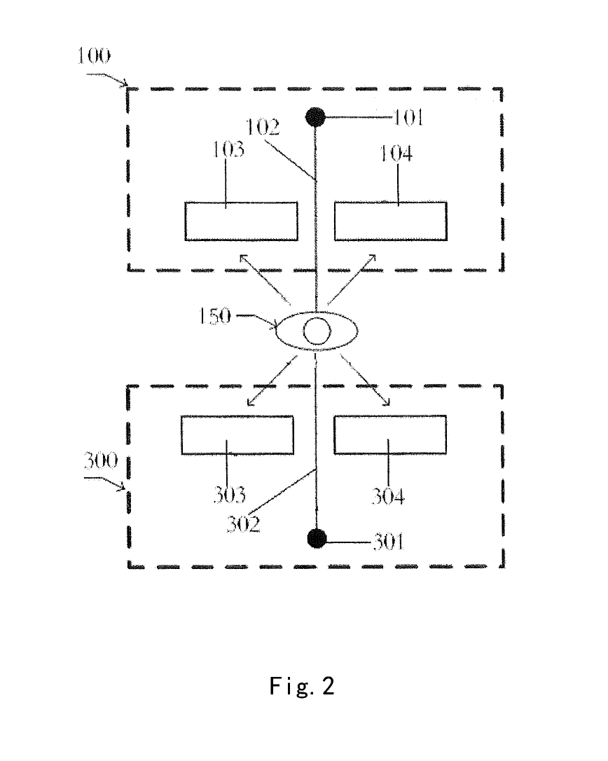

FIG. 2 shows a schematic view of another human body back-scatter scanning system for obtaining back-scatter images in accordance with another embodiment of the present invention. As shown in FIG. 2, the apparatuses 100 and 300 are two back-scatter apparatuses, each of which utilizes a flying spot forming device as described in a Chinese Patent application No. 201010624252.3 (with a publication number of CN102565110A). The detector therein includes two back-scatter detectors. The detector does not need to translate right and left, and the personal to be inspected 5 (for instance a circle in the inspection region of FIG. 2) stands within the inspection region 150. At the same time, ray beams 102 which are emitted from the X-ray source 101 of the apparatus 100, are radiated onto the personal to be inspected (for example a front side thereof) and then the scattered rays are received by the detectors 103 and 104. Meanwhile, ray beams 302 which are emitted from the x-ray source 301 of the apparatus 300, are radiated onto the personal to be inspected (for example a back side thereof) and then the scattered rays are received by the detectors 303 and 304. In this way, it is at least capable of obtaining the back-scatter images of two sides of the personal to be inspected at the same time.

Of course, it is also possible to dispose the above apparatuses 100 and 300 shifted from each other by a certain distance, that is, the apparatuses 100 and 300 are not fully in opposite to each other. For example, the apparatus 300 can be translated to the right along a horizontal direction of FIG. 2 by a certain distance. In this case, the personal to be inspected can stand onto a conveyer belt (not shown), so as to move from the inspection region 150 of the apparatus 100 to the inspection region of the apparatus 300. When the personal to be inspected is located within the scanning range of the apparatus 100, the ray source 101 of the apparatus 100 emits the ray beams 102, and they illuminate the personal to be inspected. Finally, the scattered rays are received by the detectors 103 and 104.

When the personal to be inspected is transferred to an area within the scanning range of the apparatus 300, the ray source 301 of the apparatus 300 emits the rays, and then they are radiated onto the personal to be inspected. The scattered rays are received by the detectors 303 and 304. After the personal to be inspected is transferred out of the scanning range of the apparatus 300 by means of the conveyor belt, the scanning of the human body is finished. In this way, it is not only possible to rapidly obtain the back-scatter images of several sides of the personal to be inspected, but also to avoid the interferences caused when the apparatuses 100 and 300 as arranged in FIG. 2 of the present invention simultaneously perform the inspection, thereby improving the inspection accuracy of the apparatuses.

In accordance with other embodiments of the present invention, the human body back-scatter scanning system also can use a camera, so as to rapidly acquire optical images of the personal to be inspected. These optical images are used to determine the outline information of the personal to be inspected.

It can be known from the above that the scanning images of the personal to be inspected can be obtained by, for example, the back-scatter technique as known in the art. Of course, the scanning images in the embodiment of the present invention also can be obtained by other imaging techniques such as millimetre wave, X-ray and the like, not limiting to the back-scatter imaging technique in the embodiment of the present invention.

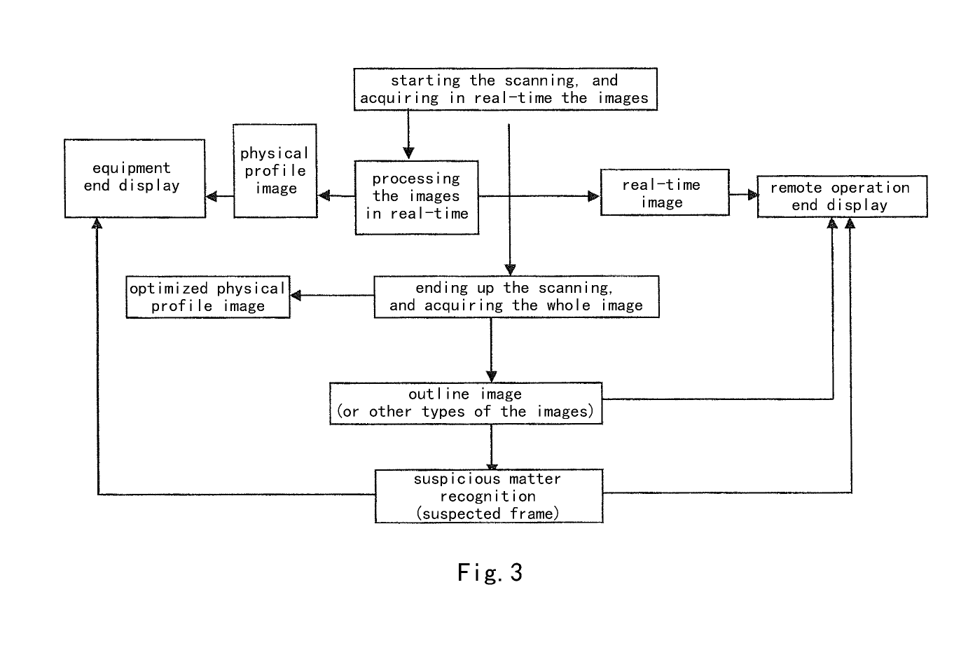

With reference to FIG. 3, the step or function of acquiring in real-time the scanning row or column data of the personal to be inspected as described in the embodiment of the present invention is achieved by the back-scatter scanning system shown in FIGS. 1 and 2 of the present invention, and thus the detailed description thereof is omitted herein.

Firstly, the step of acquiring in real-time the scanning row or column image data of the personal to be inspected is performed in the privacy protection method in the embodiment of the present invention.

Then, the scanning row or column data or the image data are transmitted in real-time by rows or columns to an algorithm processing module (not shown) within the human body security inspection system. During the scanning of the image, the algorithm processing module receives rows (columns) of image data (i.e., the scanning column or row image data) of the personal to be inspected, and these data are processed in time, so as to become the physical profile image and the outline image of the personal to be inspected. Based on the image formed from processing the scanning column or row image data, the physical profile image and the outline image of the personal to be inspected are displayed in real-time by columns or rows. The physical profile image has privacy protection function, i.e., excludes the feature information of the personal to be inspected. The outline image includes the feature information of the personal to be inspected.

In addition, in another embodiment, it is also possible to transmit an entire scanning image data to the algorithm processing module after completing the scanning of the personal to be inspected. After receiving the entire image data by the algorithm processing module, the algorithm processing is performed on the entire image data, so as to obtain the optimized physical profile image and outline image of the personal to be inspected (herein, not limiting to the outline image, other images having the similar function can also be employed).

The optimized physical profile image and outline image can be respectively displayed on the equipment end display and the remote operation end display of the human body inspection system.

After then, the suspicious matter recognition is performed within the resultant optimized outline image, and in accordance with the suspicious matter recognized in the outline image, a suspected frame is correspondingly displayed on the physical profile image. In accordance with the recognition result of the suspicious matter, a suspected frame corresponding to the size of the suspicious matter is marked at the position of the suspicious matter. The colour of the suspected frame indicates the different sorts of the suspicious matters. For example, a blue frame is used to represent a metal article, a green frame is used to represent a non-metal article, and a red frame is used to represent explosives or drugs. Of course, the colour of the suspected frame can be arbitrarily chosen, so as to represent the desired sort of the suspicious matter. The same suspected frame is displayed at the corresponding position of the physical profile image. The recognition method of the suspicious matter can be performed by the automatic target recognition (ATR) method or other recognition methods well known in the art.

The ATR method can be found from a published article of Jun HE et al. entitled “Interval estimation and sample size calculation for ATR algorithm classification accuracy” (systems engineering and electronics, No. 7 of Vol. 29, July 2007) and another article of Honggui Li entitled “An algorithm for infrared image recognition based on Gabor wavelet and neural network” (systems engineering and electronics, No. 2 of Vol. 25, 2003).

Specifically, the ATR method can be a pattern recognition method using the neural network. In the embodiment of the present invention, the ATR method includes the steps of: (a) image denoise and enhancement, wherein a wavelet denoise and enhancement method is used on basis of edge-preserving, and the information of the edge is kept as possible as it can upon smoothing the image; (b) dividing image, wherein the image is divided into several typical regions (such as, head, chest, arms and legs); (c) extracting sample features wherein the feature information such as texture (gray level co-occurrence matrix), and Nth order matrix is used as input parameters of the neural network; (d) training and recognizing of the samples, wherein the parameters of the neural network are trained by the samples, another group of samples are used to perform recognizing operation; and (e) analyzing the warned region, wherein the suspicious matter is split out from the warned region by an image segmentation algorithm.

In an embodiment of the present invention, a generation method of obtaining the physical profile image having the privacy protection function by processing the scanning image with the algorithm processing module includes the steps: (a) filtering, specifically, morphology filtering and smoothing the noise points; (b) performing binary process of image; and (c) hole-filling, specifically morphology hole-filling algorithm, to fill the holes caused by the suspicious matter within the human body.

In the process for performing the algorithm of the algorithm processing module, the initially original scanning image typically has various detail information (for example, the human body privacy information and the suspicious matter information), and the two images (i.e., the physical profile image and the outline image) can be obtained by processing the original scanning images. The physical profile image is obtained by removing the detailed information of the human body with the algorithm. During the removing process, the edges of the image become concave and/or convex and holes is present in the interior of the image due to the existence of the suspicious matter. The concave and/or convex portion of the edge and interior holes can be eliminated by correcting the image by the above described algorithm (for example, hole-filling). The outline image (not limiting to the outline image) is obtained by reprocessing the original image that has been processed for denoising and contour extraction.

It should be noted that the above described suspicious matter recognition method and the algorithm of obtaining the physical profile image and the outline image can be performed by other methods known in the art. It is not necessary to limit to the above disclosed method.

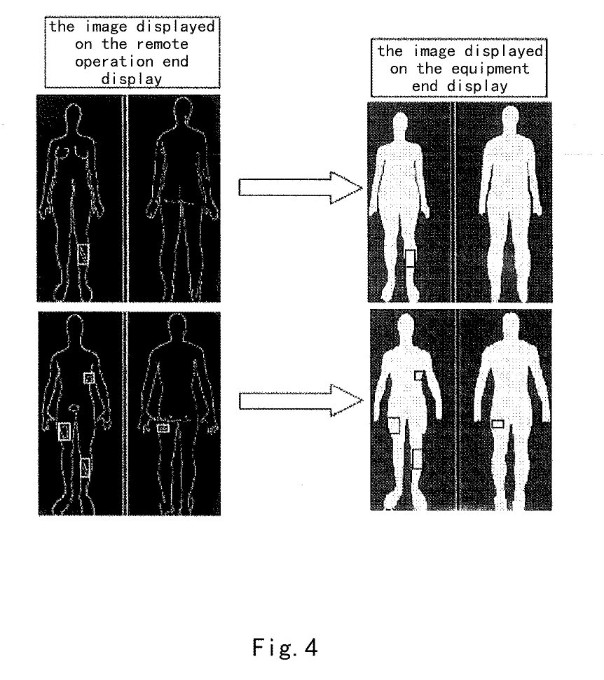

With reference to FIG. 4, finally, after the physical profile image and the outline image with the suspected frame respectively are acquired, they are displayed by a split-display technique. The physical profile image is displayed on the display (i.e., the equipment end display) carried by the human body security inspection system or the back-scatter scanning system; and the outline image is displayed on the remote operation end display. Specifically, it can be seen from the outline image at the left side of FIG. 4, some detailed features of the personal to be inspected are visible; in contrast, it is only possible to see the physical profile image matched to the personal to be inspected from the physical profile image at the right side of FIG. 4.

After finishing one inspection, the original scanning image and the outline image or the like are deleted, while only the physical profile image with the suspected frame is saved.

In an embodiment of the present invention, the physical profile image with the suspected frame is obtained by processing the original scanning image with the techniques such as the image processing, image recognition and so on; the physical profile image and the outline image (not limiting to the outline image) are respectively displayed on the equipment end display and the remote operation end display by the software split-display technique. The remote operator can see the outline image (not limiting to the outline image), but cannot see the personal to be inspected. The workers at the equipment end and the personal to be inspected only can see the physical profile image, while the image with the privacy features is not saved. In this way, the privacy can be very well protected, while achieving the accurately positioning of the suspicious matter and the distinguishing of its sort.

It can be seen from the above that the present disclosure achieves the privacy protection function in the human body security inspection by the technical means such as the image processing, the image recognition and the split-display technique. In embodiments of the present invention, the original image obtained by scanning is used to generate by means of the image processing the physical profile image, which is full matched with the original image and does not contain any specific features of the human body. Therefore, the suspicious matter can be accurately positioned, and the advantages such as rapid and stable algorithm or the like can be obtained.

The embodiments of the method and apparatus for three dimension enhanced image quality of back-scatter images have been discussed in detail through the schematic views, flowcharts and/or examples in the above detailed description. In the case that such schematic views, flowcharts and/or examples include one or more functions and/or operations, the skilled person in the art should appreciate that each function and/or operation in the schematic views, flowcharts and/or examples can be implemented separately or in combination, by various structures, hardware, software, firmware or any combination thereof. In one embodiment of the present invention, a plurality of parts of the subject matter in accordance with the embodiment of the present invention can be implemented by ASIC, FPGA, DSP or other integration forms. However, the skilled person in the art should understand that some methods of the embodiments as disclosed herein can be entirely or partly be implemented in the integration circuit as well, as one or more computer programs executed on one or more computers (for example, one or more computer programs executed on one or more computer systems), one or more computer programs executed on one or more processors (for example one or more computer programs executed on one or more microprocessors), a firmware, or any combination thereof. Furthermore, the skilled person in the art can possess the ability of designing the circuit and/or writing the software and/or the firmware code, in accordance with the present disclosure. In addition, the skilled person in the art can appreciate that the mechanism of the body of the present disclosure can be distributed as a plurality of forms of program products, and no matter how the specific types of the signal carrying medium for performing the distribution for the actual usage, the illustrative embodiment of the body of the present disclosure can be used herein. The examples of the signal carrying medium include, but not limiting to: recordable medium (for example floppy disk), hard disk driver, CD, DVD, digital magnetic tape, computer storage or the like, and the transmission medium (for example digital and/or analogy communication medium (for example, optical fibre cable, waveguide, wired communication link, wireless communication link, and so on)).

Although the present invention has been explained with reference to the drawings, the embodiments shown in the drawings are only illustrative, instead of limiting the present invention. Although some embodiments of the general inventive concept are illustrated and explained, it would be appreciated by those skilled in the art that modifications and variations may be made in these embodiments without departing from the principles and spirit of the general inventive concept of the disclosure, the scope of which is defined in the appended claims and their equivalents.

1. A privacy protection method for human body security inspection, comprising the steps of:
acquiring in real-time scanning row or column image data of a personal to be inspected;
displaying a physical profile image and an outline image of the personal to be inspected, on basis of the processed image of the scanning row or column image data;
transmitting the physical profile image to an equipment end display in a human body security inspection system and displaying it thereon, and displaying the outline image of the personal to be inspected on a remote operation end display of the human body security inspection system;
performing a suspicious matter recognition based on the outline image; and
correspondingly displaying a suspected frame on the physical profile image, based on the suspicious matter recognized in the outline image.

2. The privacy protection method of claim 1, further comprising:
a step of optimizing the physical profile image and the outline image based on an entire original scanning image of the personal to be inspected obtained after completing the scanning, after the step of displaying in real-time the physical profile image and the outline image of the personal to be inspected.

3. The privacy protection method of claim 1 or 2, wherein
the suspected frame matched with the suspicious matter is correspondingly displayed on the physical profile image, based on a sort of the recognized suspicious matter and its position and size in the outline image.

4. The privacy protection method of claim 3, wherein
a colour of the suspected frame represents the sort of the suspicious matter.

5. The privacy protection method of claim 4, wherein
a suspected blue frame represents a metal article, a suspected green frame represents a non-metal article, and a suspected red frame represents explosives or drugs.

6. The privacy protection method of claim 1, wherein
the physical profile image is fully matched with an outline of the personal to be inspected, but excludes detailed features of the personal to be inspected.

7. The privacy protection method of claim 6, wherein
the physical profile image and the outline image of the personal to be inspected are simultaneously obtained from the original scanning image, by means of the algorithm processing module in the human body security inspection system.

8. The privacy protection method of claim 7, wherein
the physical profile image is obtained by removing the detailed features of the personal to be inspected with algorithm of the algorithm processing module.

9. The privacy protection method of claim 8, wherein
during the removing step, mending and removing concave and/convex portion of edges of the physical profile image and/or holes in an interior of the physical profile image caused by presence of the suspicious matter, by means of the algorithm.

10. The privacy protection method of claim 7, wherein
the outline image is obtained by denoising and contour extracting the original scanning image.

11. A human body security inspection system with privacy protection function, comprising:
a device configured to acquire scanning images of a personal to be inspected within a scanning region;
a device configured to obtain a physical profile image of the personal to be inspected based on the scanning images;
a device configured to obtain an outline image of the personal to be inspected based on the scanning images;
a device configured to determine a suspicious matter carried by the personal to be inspected from the outline image;
a device configured to display a suspected frame on the physical profile image based on the suspicious matter recognized in the outline image; and
a device configured to display the physical profile image and the outline image on an equipment end display and a remote operation end display of the human body security inspection system respectively in a form of split-display.

12. The human body security inspection system of claim 11, wherein
the suspected frame matched with the suspicious matter is correspondingly displayed on the physical profile image, based on a sort of the recognized suspicious matter and its position and size in the outline image.

13. The human body security inspection system of claim 12, wherein
a colour of the suspected frame represents the sort of the suspicious matter.

14. The human body security inspection system of claim 13, wherein
a suspected blue frame represents a metal article, a suspected green frame represents a non-metal article, and a suspected red frame represents explosives or drugs.

15. The human body security inspection system of claim 11, wherein
the physical profile image is fully matched with an outline of the personal to be inspected, but excludes detailed features of the personal to be inspected.

16. The human body security inspection system of claim 15, wherein
the physical profile image and the outline image of the personal to be inspected are simultaneously obtained from the original scanning image, by means of an algorithm processing module in the human body security inspection system.

17. The human body security inspection system of claim 16, wherein
the physical profile image is obtained by removing the detailed features of the personal to be inspected with algorithm of the algorithm processing module.

18. The human body security inspection system of claim 17, wherein
during the removing step, mending and removing concave and/or convex portions of edges of the physical profile image and/or holes in an interior of the physical profile image caused by presence of the suspicious matter, by means of the algorithm.

19. The human body security inspection system of claim 16, wherein
the outline image is obtained by performing denoising and contour extracting process on the original scanning image.
